(19) United States
(12) Patent Application Publication
(10) Pub. No.: US 2021/0311605 A1
(43) Pub. Date: Oct. 7, 2021

(54) TOUCH DETECTION METHOD FOR TOUCH SCREEN, TOUCH SCREEN ASSEMBLY AND DISPLAY PANEL ASSEMBLY

(71) Applicant: SHENZHEN ROYOLE TECHNOLOGIES CO., LTD., Shenzhen (CN)

(72) Inventors: Zening Jiang, Shenzhen (CN); Dongguang Wu, Shenzhen, (CN)

(21) Appl. No.: 17/350,390

(22) Filed: Jun. 17, 2021

Related U.S. Application Data
(63) Continuation of application No. PCT/CN2018/122076, filed on Dec. 19, 2018.

(51) Int. Cl. G06F 3/041; G06F 3/044

(52) U.S. Cl. CPC G06F 3/04182; G06F 2203/04111; G06F 3/0446; G06F 3/0412

(57) ABSTRACT

Disclosed are a touch detection method for a touch screen, a touch screen assembly (200) and a display panel assembly (100). The touch screen (30) includes multiple touch sensors arranged in an array, multiple row driving wires and multiple column receiving wires, each of the row driving wires is connected to one row of the touch sensors, and each of the column receiving wires is connected to one column of the touch sensors. The touch detection method includes: providing a driving signal to the row driving wires; differentially amplifying outputs of any two adjacent column receiving wires separately to obtain multiple differentially amplified signals; amplifying an output of any column receiving wire to obtain a single-ended amplified signal; determining that all column receiving wires corresponding to the same row driving wire are touched; and determining that all column receiving wires corresponding to the same row driving wire are not touched.

### TECHNICAL FIELD

The present application relates to the field of touch technologies, and in particular, to a touch detection method for a touch screen, a touch screen assembly and a display panel assembly.

### BACKGROUND

A touch screen of the related technologies includes multiple touch sensors arranged in an array, multiple row driving wires (RX) and multiple column receiving wires (TX). Each of the row driving wires is connected to the all touch sensors at one corresponding row, and each of the column receiving wires is connected to the all touch sensors at one corresponding column. During operation, a driving signal is sent to the row driving wires, and signal outputs of the column receiving wires are detected. A touch position is determined based on a signal change of the column receiving wires.

However, the current touch screen cannot identify cases in which touch sensors connected to a whole row driving wire are all touched or not touched, causing a detection blind spot in touch detection.

### SUMMARY

In view of this, the embodiments of the present application provide a touch detection method for a touch screen, a touch screen assembly and a display panel assembly.

An implementation of the present application provides a touch detection method for a touch screen, where the touch screen is applied to a touch screen assembly; the touch screen includes multiple touch sensors arranged in an array, multiple row driving wires and multiple column receiving wires, each of the row driving wires is connected to one row of the touch sensors, and each of the column receiving wires is connected to one column of the touch sensors; and the touch detection method includes:

providing a driving signal to the row driving wires;

differentially amplifying outputs of any two adjacent column receiving wires separately to obtain multiple differentially amplified signals;

amplifying an output of any column receiving wire to obtain a single-ended is amplified signal;

when first absolute differences between each of the differentially amplified signals and a reference value are all less than a first threshold and a second absolute difference between the single-ended amplified signal and the reference value is not less than a second threshold, determining that all column receiving wires corresponding to the same row driving wire are touched; and

when the first absolute differences are all less than the first threshold and the second absolute difference is less than the second threshold, determining that all column receiving wires corresponding to the same row driving wire are not touched, where the reference value refers to an average value of the multiple differentially amplified signals in a case that the touch screen is not touched.

An implementation of the present application provides a touch screen assembly, including a touch screen and a touch detection circuit, where the touch screen includes multiple touch sensors arranged in an array, multiple row driving wires and multiple column receiving wires, each of the row driving wires is connected with all touch sensors on the corresponding row, and each of the column receiving wires is connected with all touch sensors on the corresponding column; and the touch detection circuit includes:

a drive circuit, configured to provide driving signals to the row driving wires;

multiple first differential amplifiers, configured to differentially amplify outputs of any two adjacent column receiving wires separately to obtain multiple differentially amplified signals;

a second differential amplifier, configured to amplify an output of any column receiving wire to obtain a single-ended amplified signal; and

a processing circuit, connected to the first differential amplifiers and the second differential amplifier and configured to: when first absolute differences between each of the differentially amplified signals and a reference value are all less than a first threshold and a second absolute difference between the single-ended amplified signal and the reference value is not less than a second threshold, determine that all column receiving wires corresponding to the same row driving wire are touched; and when the first absolute differences are all less than the first threshold and the second absolute difference is less than the second threshold, determine that all column receiving wires corresponding to the same row driving wire are not touched, where

the reference value refers to an average value of the multiple differentially amplified signals in a case that the touch screen is not touched.

An implementation of the present application provides a display panel assembly, including a display panel and the above-mentioned touch screen assembly, where the touch screen is disposed on the display panel.

According to the touch detection method for a touch screen, the touch screen assembly and the display panel assembly described above, a single-ended amplified signal is added to any column receiving wire. As such, even when first absolute differences between each of the differentially amplified signals and a reference value are all less than a first threshold but whether column receiving wires come in touch is with a whole row driving wire cannot be determined, a determination can be made by comparing a second absolute difference between the single-ended amplified signal and the reference value with a second threshold, thereby eliminating a blind spot in touch detection.

Additional aspects and advantages of the implementations of the present application will be set forth in part in the description below, and in part will be apparent from the following descriptions, or may be learned by practice of the implementations of the present application.

### BRIEF DESCRIPTION OF DRAWINGS

The preceding and/or additional aspects and advantages of the present application will become apparent and readily understood from the following description of implementations with reference to the accompanying drawings, in which:

FIG. 1 is a schematic flowchart illustrating a touch detection method for a touch screen according to an implementation of the present application;

FIG. 2 is a schematic structural diagram illustrating a touch screen assembly according to an implementation of the present application;

FIG. 3 is another schematic structural diagram illustrating a touch screen assembly according to an implementation of the present application;

FIG. 4 is a schematic diagram illustrating a principle of a touch detection method for a touch screen according to an implementation of the present application; and

FIG. 5 is a schematic structural diagram illustrating a display panel assembly according to an implementation of the present application.

### DESCRIPTION OF EMBODIMENTS

The following describes in detail the implementations of the present application. Examples of the implementations are illustrated in the accompanying drawings, in which identical or similar reference numerals refer to identical or similar elements or elements having identical or similar functions throughout. The implementations described below with reference to the accompanying drawings are exemplary, are merely intended to explain the present application, and cannot be construed as a limitation to the present application.

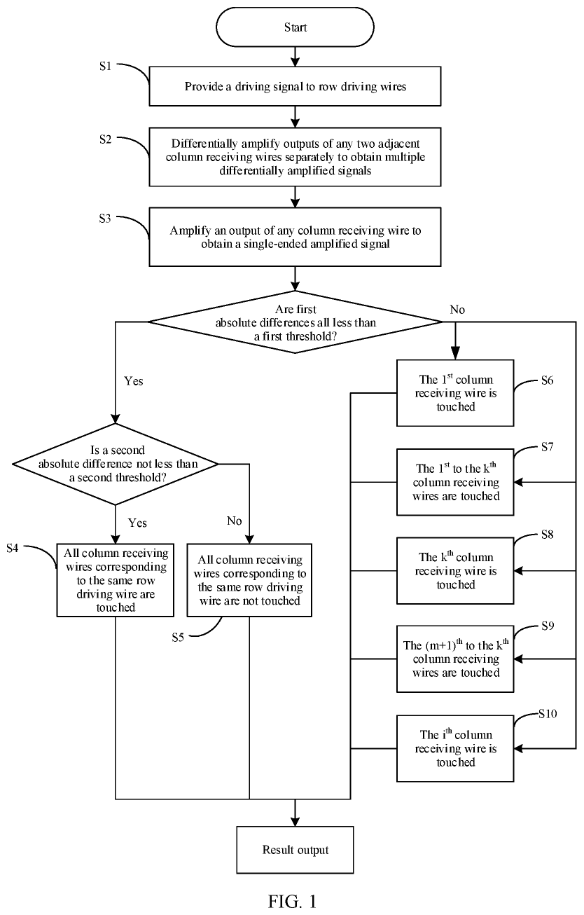

Referring to FIG. 1 to FIG. 3, a touch detection method according to an implementation of the present application may be applied to a touch screen assembly 200 according to an implementation of the present application. The touch screen assembly 200 includes a touch detection circuit 10 and a touch screen 30.

The touch screen 30 includes multiple touch sensors Cji, multiple row driving wires TX and multiple column receiving wires RX, where each of the row driving wires is connected to all the touch sensors of one row, and each of the column receiving wires is connected to all the touch sensors of one column. The multiple touch sensors Cji are arranged in an array to form a touch sensor array, and i*j touch sensors are arranged into i columns and j rows, where i and j are positive integers, j represents a row ordinal number of the touch sensors Cji, and i represents a column ordinal number of the touch sensors Cji.

In the implementation of the present application, the touch sensors are capacitive sensors. Specifically, each of the row driving wires TX is connected to one electrode corresponding to one row of the capacitive sensors, and each of the column receiving wires RX is connected to another electrode corresponding to one column of the capacitive sensors.

The touch detection method for a touch screen in the implementation of the present application includes the following steps.

Step S1. Provide driving signals to row driving wires TX.

Specifically, the touch detection circuit in the implementation of the present application includes a drive circuit 40 that provides the driving signals to the row driving wires TX, and the driving signal provided by the drive circuit 40 include a pulse width modulated signal (PWM signal).

Step S2. Differentially amplify outputs of any two adjacent column receiving wires RX separately to obtain multiple differentially amplified signals.

In the illustrated implementation, there are i column receiving wires, the multiple differentially amplified signals include i−1 differentially amplified signals, and i>2.

The outputs of any two adjacent column receiving wires RX are differentially amplified. For example, outputs of column receiving wires RX1 and RX2 are differentially amplified to obtain a first differentially amplified signal, and outputs of column receiving wires RX2 and RX3 are differentially amplified to obtain a second differentially amplified signal, etc.

Step S3. Amplify an output of any column receiving wire RX to obtain a single-ended amplified signal.

Specifically, in the illustrated implementation, the single-ended amplified signal includes a first single-ended amplified signal obtained by amplifying an output of the 1^{st} column receiving wire and a second single-ended amplified signal obtained by amplifying an output of the i^{th} column receiving wire. That is, there are two single-ended amplified signals. In another implementation, an output of any column receiving wire RXi may also be amplified to obtain a single-ended amplified signal.

Step S4. When first absolute differences between each of the differentially amplified signals and a reference value are all less than a first threshold and a second absolute difference between the single-ended amplified signal and the reference value is not less than a second threshold, determine that all column receiving wires corresponding to the same row driving wire are touched.

Step S5. When the first absolute differences are all less than the first threshold and the second absolute difference is less than the second threshold, determine that all column receiving wires corresponding to the same row driving wire are not touched.

The reference value refers to an average value of the multiple differentially amplified signals in a case that the touch screen 30 is not touched.

According to the above-mentioned touch detection method for a touch screen, a single-ended amplified signal is added to any column receiving wire. As such, even when first absolute differences between all differentially amplified signals and a is reference value are all less than a first threshold but whether column receiving wires come in touch with a whole row driving wire cannot be determined, a determination can be made by comparing a second absolute difference between the single-ended amplified signal and the reference value with a second threshold, thereby eliminating a blind spot in touch detection.

Further, when corresponding column receiving wires are touched (that is, touch sensors connected to the column receiving wires are touched), the second absolute difference between the single-ended amplified signal and the reference value is not less than the second threshold; and when the corresponding column receiving wires are not touched, the second absolute difference between the single-ended amplified signal and the reference value is less than the second threshold. The absolute difference refers to an absolute value of a difference.

It can be understood that, a first range defined by positive and negative first thresholds can be regarded as a range of noise that is output when a touch sensor corresponding to an output differentially amplified signal is not touched. Within the first range, a strength fluctuation of the differentially amplified signal may be regarded as the fact that the touch sensor is not touched. Similarly, a second range defined by positive and negative second thresholds can be regarded as a range of noise that is output when a touch sensor corresponding to an output single-ended amplified signal is not touched. Within the second range, a strength fluctuation of the single-ended amplified signal may be regarded as the fact that the touch sensor is not touched. The first threshold and the second threshold are both greater than 0 and may be calibrated is by testing. In some examples, the first threshold may be equal to the second threshold.

In the example of FIG. 1, step S2 is performed before step S3. It can be understood that, in another implementation, step S2 may be performed after step S3, or steps S2 and S3 may be performed simultaneously.

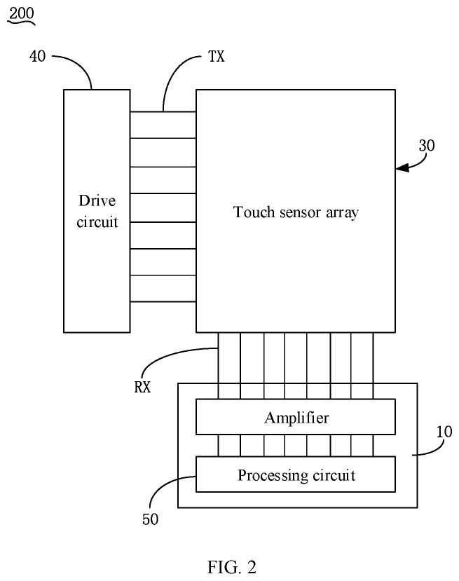

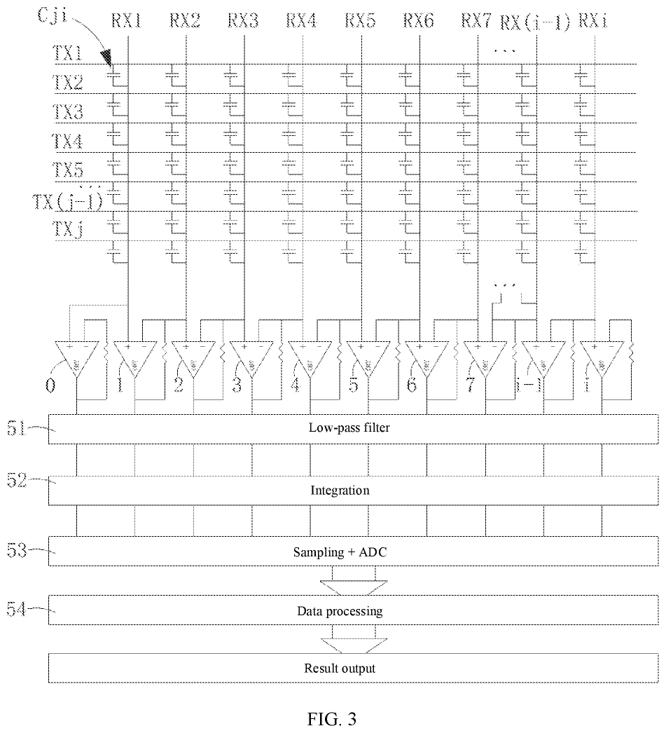

Referring to FIG. 3, the touch detection circuit in the implementation of the present application includes multiple first differential amplifiers, a second differential amplifier and a processing circuit 50 connected to the first differential amplifiers and the second differential amplifier. Two input ends of each of the first differential amplifiers are respectively connected to two adjacent column receiving wires, and one input end of the second differential amplifier is connected to any column receiving wire. In FIG. 2, the first differential amplifiers and the second differential amplifier constitute an amplifier.

The multiple first differential amplifiers are configured to differentially amplify outputs of any two adjacent column receiving wires separately to obtain multiple differentially amplified signals. The second differential amplifier is configured to amplify an output of any column receiving wire to obtain a single-ended amplified signal.

The processing circuit 50 is configured to: when first absolute differences between the differentially amplified signals and a reference value are all less than a first threshold and a second absolute difference between the single-ended amplified signal and the reference value is not less than a second threshold, determine that all column receiving wires corresponding to the same row driving wire are touched; and is when the first absolute differences are all less than the first threshold and the second absolute difference is less than the second threshold, determine that all column receiving wires corresponding to the same row driving wire are not touched.

Specifically, in the illustrated orientation, in two adjacent column receiving wires, a positive input end of a first differential amplifier is connected to the column receiving wire on the left, a negative input end of the first differential amplifier is connected to the column receiving wire on the right, and a first resistor is connected between the negative input end and an output end to form a negative feedback. It can be understood that, in another implementation, the negative input end of the first differential amplifier may alternatively be connected to the column receiving wire on the left, and the positive input end of the first differential amplifier may be connected to the column receiving wire on the right. In other words, the two input ends of the first differential amplifier are respectively connected to the two adjacent column receiving wires.

In the illustrated implementation, there are i−1 first differential amplifiers, numbered 1, 2, 3, . . . and i−1 from left to right, respectively. First differential amplifier 1 is connected to the 1st column receiving wire and the 2′ column receiving wire, first differential amplifier 2 is connected to the 2′ column receiving wire and the 3′ column receiving wire, and first differential amplifier i−1 is connected to the (i−1)^{th} column receiving wire and the i^{th} column receiving wire. The multiple differentially amplified signals include i−1 differentially amplified signals, first differential amplifier 1 outputs the 1^{st} differentially amplified signal, first differential amplifier 2 outputs the 2^{nd} differentially amplified signal, and first differential amplifier i−1 outputs the (i−1)^{th} differentially amplified signal.

In the illustrated implementation, there are two second differential amplifiers, numbered 0 and i from left to right, respectively. A positive input end of second differential amplifier 0 is connected to the 1st column receiving wire, and a second resistor is connected between a negative input end and an output end to form a negative feedback. A positive input end of second differential amplifier i is connected to the i^{th} column receiving wire, and a second resistor is connected between a negative input end and an output end to form a negative feedback. Therefore, in the illustrated implementation, the single-ended amplified signal includes a first single-ended amplified signal obtained by amplifying an output of the 1^{st} column receiving wire and a second single-ended amplified signal obtained by amplifying an output of the i^{th} column receiving wire.

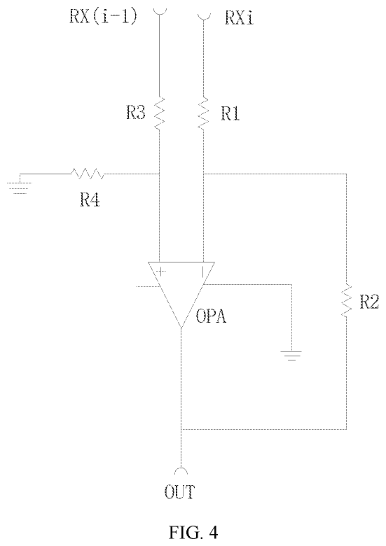

A differential amplification principle is shown in FIG. 4, where RXi and RX(i−1) are input signals of the amplifier, Vout is an output signal (voltage) of the amplifier, and R1, R2, R3 and R4 are resistors controlling a differential amplification factor. Preferably, R1=R3, and R2=R4.

A differential amplification formula is: Vout=(RX(i−1)−RXi)*R4/R3.

When the input signal RX(i−1) is greater than RXi, Vout is output as positive; when RX(i−1) is less than RXi, Vout is output as negative; and when RX(i−1) is equal to RXi, Vout is output as 0.

In practice, because RX(i−1) is not necessarily equal to RXi, an original value is obtained when the touch screen is not touched is used as the reference value. When a touch occurs in a channel RXi, the input signal RXi becomes smaller, RX(i−1) remains unchanged, RX(i−1)−RXi becomes larger, Vout is greater than the reference value, and a difference Delta between a differentially amplified signal and the reference value is positive. When a touch occurs in a channel RX(i−1), the input signal RX(i−1) becomes smaller, RXi remains unchanged, RX(i−1)−RXi becomes smaller, Vout is less than the reference value, and the difference Delta between the differentially amplified signal and the reference value is negative. When no touch occurs in the channel RX(i−1) and the channel RXi, the difference Delta between the differentially amplified signal and the reference value is 0.

It can be learned from the above that, a difference Delta between a processed value and a reference value can be output based on each amplifier, and the reference value is a reference value of a differential amplification output in a case that the touch screen is not touched. Based on a size of the Delta and a polarity of an adjacent Delta, a specific column receiving wire RX connected to a touch sensor on which a touch position occurs can be determined. Then, a position of a touch point is determined based on correspondences with the row driving wires TX and the specific column receiving wire RX. For relationships between the column receiving wire RX on which the touch position is located and Deltas, refer to Table 1. For channels R1 and Ri, only one Delta value is determined to identify whether there is a touch. For other channels R2 to Ri−1, two Deltas with opposite polarities can be determined to identify whether there is a touch.

TABLE 1

| | R2 | R2 | R3 | R4 | R5 | . . . | Ri-1 | Ri |
|---|---|---|---|---|---|---|---|---|
| Delta1 | Negative | Positive | | | | | | |
| Delta2 | | Negative | Positive | | | | | |
| Delta3 | | | Negative | Positive | | | | |
| Delta4 | | | | Negative | Positive | | | |
| Delta5 | | | | | Negative | | | |
| Delta (i-2) | | | | | | | Positive | |
| Delta (i-1) | | | | | | | Negative | Negative |

In actual applications, as described above, a touch screen may be affected by noise, and a differentially amplified signal fluctuates even when the touch screen is not touched. In this case, a difference Delta between the differentially amplified signal and a reference value is not 0. Therefore, the first threshold is set. When an absolute difference between the differentially amplified signal and the reference value is less than the first threshold, the difference Delta between the differentially amplified signal and the reference value may be regarded as 0.

In the implementation of the present application, the column receiving wires may be regarded as output channels of the touch sensors. Therefore, for the first differential amplifiers, regardless of whether a touch occurs in the channel RXi or the channel RX(i−1), the first absolute differences between the first differentially amplified signals and the reference value are not less than the first threshold. When a touch occurs simultaneously in the channel RXi and the channel RX(i−1), or no touch occurs in the channel RXi and the channel RX(i−1), the first absolute differences between the first differentially amplified signals and the reference value are less than the first threshold. For the second differential amplifier, when a touch occurs in a channel RX1, a second is absolute difference between the first single-ended amplified signal and the reference value is not less than the second threshold; and when a touch occurs in the channel RXi, a second absolute difference between the second single-ended amplified signal and the reference value is not less than the second threshold. When no touch occurs in the channel RX1, the second absolute difference between the first single-ended amplified signal and the reference value is less than the second threshold; and when no touch occurs in the channel RXi, the second absolute difference between the second single-ended amplified signal and the reference value is less than the second threshold. It should be noted that, the first differential amplifiers and the second differential amplifier are connected to a touch sensor array 30 in different ways. Specifically, the two input ends of each of the first differential amplifiers are connected to the touch sensor array 30, only one input end of the second differential amplifier is connected to the touch sensor array, and the other input end is connected to an output end. Therefore, two thresholds, i.e., the first threshold and the second threshold, are set to determine whether a touch occurs in a corresponding channel. Therefore, a determination result is relatively accurate. Specific values of the first threshold and the second threshold can be calibrated by testing. For example, an output of the touch screen assembly is simulated in a case in which no touch occurs or a touch occurs, and impact of some external interference on the touch screen assembly is also simulated, so as to finally determine a specific threshold size.

The following describes the above-mentioned implementation by using a specific example. For description simplicity, when an absolute difference (that is, an is absolute value of a difference Delta) between a differentially amplified signal or a single-ended amplified signal and a reference value is less than a threshold, the difference Delta between the differentially amplified signal or the single-ended amplified signal and the reference value is set to 0.

In the following example, Delta® represents a difference (the first single-ended amplified signal) between second differential amplifier 0 and the reference value, Delta1 represents a difference between first differential amplifier 1 and the reference value, Delta2 represents a difference between first differential amplifier 2 and the reference value, Delta(i−1) represents a difference between first differential amplifier i−1 and the reference value, and Deltai represents a difference (the second single-ended amplified signal) between second differential amplifier i and the reference value. Other information that is not illustrated may be obtained by analogy.

Referring to Table 2, Table 2 describes a case that all column receiving wires corresponding to the same row driving wire are touched.

TABLE 2

| | Delta0 | Delta1 | Delta2 | Delta3 | Delta4 | Delta5 | Delta6 | . . . | Delta (i-2) | Delta (i-1) | Deltai |
|---|---|---|---|---|---|---|---|---|---|---|---|
| R1 | Negative | 0 | 0 | 0 | 0 | 0 | 0 | | 0 | 0 | Negative |
| R2 | | | | | | | | | | | |
| R3 | | | | | | | | | | | |
| R4 | | | | | | | | | | | |
| R5 | | | | | | | | | | | |
| R6 | | | | | | | | | | | |
| . . . | | | | | | | | | | | |
| Ri-1 | | | | | | | | | | | |
| Ri | | | | | | | | | | | |

Analysis: It can be learned from the table above that, Delta0 and Deltai are negative numbers, indicating that both the 1st column receiving wire and the i^{th} (that is, the last) receiving wire that are corresponding to the same row driving wire are touched. As such, Delta1 to Delta(i−1) in the middle are 0, indicating that the 1^{st} to the (i−1)^{th} column receiving wires that are corresponding to the same row driving wire are touched.

Referring to Table 3, Table 3 describes that all column receiving wires corresponding to the same row driving wire are not touched.

TABLE 3

| | Delta0 | Delta1 | Delta2 | Delta3 | Delta4 | Delta5 | Delta6 | . . . | Delta (i-2) | Delta (i-1) | Deltai |
|---|---|---|---|---|---|---|---|---|---|---|---|
| R1 | 0 | 0 | 0 | 0 | 0 | 0 | 0 | | 0 | 0 | 0 |
| R2 | | | | | | | | | | | |
| R3 | | | | | | | | | | | |
| R4 | | | | | | | | | | | |
| R5 | | | | | | | | | | | |
| R6 | | | | | | | | | | | |
| . . . | | | | | | | | | | | |
| Ri-1 | | | | | | | | | | | |
| Ri | | | | | | | | | | | |

Analysis: It can be learned from the table above that, both Delta® and Deltai are 0, indicating that the 1^{st} column receiving wire and the i^{th} column receiving wire that are corresponding to the same row driving wire are not touched. As such, Delta1 to Delta(i−1) in the middle are 0, indicating that the l′ to the WO′ column receiving wires that are corresponding to the same row driving wire are not touched.

In the implementation of the present application, the touch detection method further includes:

removing noise of output signals of the multiple first differential amplifiers to obtain multiple first denoised signals, and remove noise of an output signal of the second differential amplifier to obtain a second denoised signal;

integrating the multiple first denoised signals and the second denoised signal respectively to obtain multiple first integrated signals and a second integrated signal;

performing sampling and analog-to-digital conversion on the multiple first integrated signals and the second integrated signal to obtain multiple first digital signals and a second digital signal, where the first digital signals serve as the differentially amplified signals and the second digital signal serves as the single-ended amplified signal; and

processing the first digital signals and the second digital signal to obtain relationships between the first absolute differences and the first threshold and a relationship between the second absolute difference and the second threshold.

As such, comparison using digital signals as a touch result is highly universal.

Specifically, the processing circuit 50 includes a low-pass filter 51, an integrator 52, a sampler/converter 53 and a processor 54.

The low-pass filter 51 is configured to remove noise of output signals of the multiple first differential amplifiers to obtain multiple first denoised signals, and remove noise of an output signal of the second differential amplifier to obtain a second denoised signal. The integrator 52 is configured to integrate the multiple first denoised signals and the second denoised signal to obtain multiple first integrated signals and a second integrated signal. The sampler/converter 53 is configured to perform sampling and analog-to-digital conversion on the multiple first integrated signals and the second integrated signal to obtain multiple first digital signals and a second digital signal, where the first digital signals serve as the differentially amplified signals and the second digital signal serves as the single-ended amplified signal. The processor 54 is configured to process the first digital signals and the second digital signal to obtain relationships between the first absolute differences and the first threshold and a relationship between the second absolute difference and the second threshold. In an example, the processor 54 is a micro control unit (MCU), and the processor 54 is further configured to output a processing result.

In some implementations, the touch detection method further includes the following steps.

Step S6. When the second absolute difference between the first single-ended amplified signal and the reference value is not less than the second threshold, the first absolute difference between the 1^{st} differentially amplified signal and the reference value is greater than the first threshold, and the first absolute differences between the 2^{nd} to the (i−1)^{th} differentially amplified signals and the reference value are all less than the first threshold, determine that the 1^{st} column receiving wire is touched.

Step S7. When the first absolute difference between the k^{th} differentially amplified signal and the reference value is greater than the first threshold, and the first absolute differences between the 1^{st} to the (k−1)^{th} differentially amplified signals and the reference value are all less than the first threshold, determine that the 1^{st} to the k^{th} column receiving wires are touched, where 1<k<i and i is a natural number.

Step S8. When the first absolute differences between the (k−1)^{th} and the k^{th} differentially amplified signals and the reference value are greater than the first threshold, and a polarity of a difference between the (k−1)^{th} differentially amplified is signal and the reference value is opposite to a polarity of a difference between the k^{th} differentially amplified signal and the reference value, determine that the k′ column receiving wire is touched.

Step S9. When the first absolute differences between the m^{th} and the k^{th} differentially amplified signals and the reference value are greater than the first threshold, a polarity of a difference between the m′ differentially amplified signal and the reference value is opposite to the polarity of the difference between the k^{th} differentially amplified signal and the reference value, and the first absolute differences between the (m+1)^{th} to the (k−1)^{th} differentially amplified signals and the reference value are all less than the first threshold, determine that the (m+1)^{th} to the k^{th} column receiving wires are touched, where k>m≥1.

Step S10. When the second absolute difference between the second single-ended amplified signal and the reference value is not less than the second threshold, the first absolute difference between the (i−1)^{th} differentially amplified signal and the reference value is greater than the first threshold, and the first absolute differences between the 1^{st} to the (i−2) th differentially amplified signals and the reference value are all less than the first threshold, determine that the i^{th} column receiving wire is touched.

As such, a touched position on the touch screen can be determined.

Specifically, the positive input end of the first differential amplifier is connected to RX(i−1), and the negative input end thereof is connected to RXi. Therefore, after it is determined that the k^{th} column receiving wire is touched, the is polarity of the difference between the (k−1)^{th} differentially amplified signal and the reference value is positive, and the polarity of the difference between the k^{th} differentially amplified signal and the reference value is negative. After it is determined that the (m+1)^{th} to the k^{th} column receiving wires are touched, the polarity of the difference between the m^{th} differentially amplified signal and the reference value is positive, and the polarity of the difference between the k^{th} differentially amplified signal and the reference value is negative.

In another implementation, if the negative input end of the first differential amplifier is connected to RX(i−1) and the positive input end thereof is connected to RXi, the polarities of the preceding differences are opposite.

In some implementations, the drive circuit 40 includes row drive circuits, and the row drive circuits are configured to provide the driving signals to each of the row driving wires. As such, the drive circuit 40 can drive each row of the touch sensors in a time-sharing way.

In some implementations, the drive circuit 40 includes a row drive circuit and a multiplexer, the multiplexer is connected to the row drive circuit and the multiple row driving wires, and the row drive circuit is configured to simultaneously provide the driving signals to the row driving wires in different rows through the multiplexer. As such, the drive circuit 40 can simultaneously drive each row of the touch sensors.

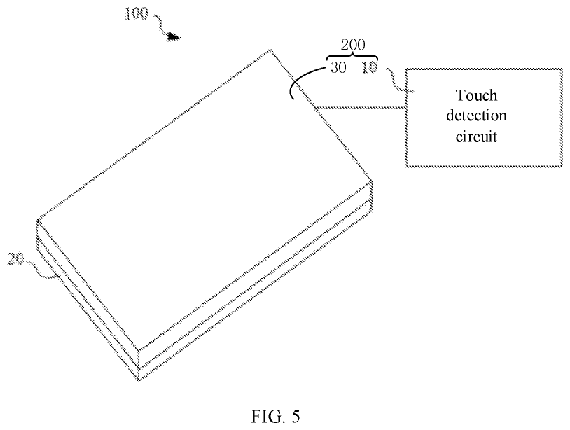

Referring to FIG. 5, a display panel assembly 200 according to an implementation of the present application includes a touch screen assembly 200 and a display panel 20. A touch screen 30 is disposed on the display panel 20.

In the display panel assembly above, a single-ended amplified signal is added to any column receiving wire. As such, even when first absolute differences between all differentially amplified signals and a reference value are all less than a first threshold but whether column receiving wires come in touch with a whole row driving wire cannot be determined, a determination can be made by comparing a second absolute difference between the single-ended amplified signal and the reference value with a second threshold, thereby eliminating a blind spot in touch detection.

The display panel 20 may include a liquid crystal display panel, an organic light-emitting display panel, a plasma display panel, or a field emission display panel.

In the illustrated implementation, the touch screen 30 is stacked on the display panel 20. It can be understood that, in another implementation, the touch screen may be formed within the display panel.

Although the embodiments of the present application have been shown and described above, it can be understood that the embodiments above are exemplary and should not be construed as a limitation to the present application. A person of ordinary skill in the art may make variations, modifications, replacements and transformations to the above-mentioned embodiments within the scope of the present application, which is defined by the claims and their equivalents.

What is claimed is:

1. A touch detection method for a touch screen, wherein the touch screen is applied to a touch screen assembly; the touch screen comprises multiple touch sensors arranged in an array, multiple row driving wires and multiple column receiving wires, each of the row driving wires is connected to one row of the touch sensors, and each of the column receiving wires is connected to one column of the touch sensors; and the touch detection method comprises:
providing a driving signal to the row driving wires;
differentially amplifying outputs of any two adjacent column receiving wires separately to obtain multiple differentially amplified signals;
amplifying an output of any column receiving wire to obtain a single-ended amplified signal;
when first absolute differences between each of the differentially amplified signals and a reference value are all less than a first threshold and a second absolute difference between the single-ended amplified signal and the reference value is not less than a second threshold, determining that all column receiving wires corresponding to the same row driving wire are touched; and
when the first absolute differences are all less than the first threshold and the second absolute difference is less than the second threshold, determining that all column receiving wires corresponding to the same row driving wire are not touched, wherein the reference value refers to an average value of the multiple differentially amplified signals in a case that the touch screen is not touched.

2. The touch detection method for a touch screen according to claim 1, wherein the driving signal comprises a PWM signal.

3. The touch detection method for a touch screen according to claim 1, wherein the touch screen assembly comprises multiple first differential amplifiers and a second differential amplifier, two input ends of each of the first differential amplifiers are respectively connected to two adjacent column receiving wires, and one input end of the second differential amplifier is connected to any column receiving wire; and the touch detection method further comprises:
removing noise of output signals of the multiple first differential amplifiers to obtain multiple first denoised signals, and removing noise of an output signal of the second differential amplifier to obtain a second denoised signal;
integrating the multiple first denoised signals and the second denoised signal respectively to obtain multiple first integrated signals and a second integrated signal;
performing sampling and analog-digital conversion on the multiple first integrated signals and the second integrated signal to obtain multiple first digital signals and a second digital signal, wherein the first digital signals serve as the differentially amplified signals and the second digital signal serves as the single-ended amplified signal; and
processing the first digital signals and the second digital signal to obtain relationships between the first absolute differences and the first threshold and a relationship between the second absolute difference and the second threshold.

4. The touch detection method for a touch screen according to claim 1, wherein there are i column receiving wires, the single-ended amplified signal comprises a first single-ended amplified signal obtained by amplifying an output of the 1^{st} column receiving wire and a second single-ended amplified signal obtained by amplifying an output of the i^{th} column receiving wire, i>2 and i is a natural number, and the multiple differentially amplified signals comprise i−1 differentially amplified signals; and
the touch detection method further comprises:
when the second absolute difference between the first single-ended amplified signal and the reference value is not less than the second threshold, the first absolute difference between the 1^{st} differentially amplified signal and the reference value is greater than the first threshold, and the first absolute differences between the 2^{nd} to the (i−1)^{th} differentially amplified signals and the reference value are all less than the first threshold, determining that the first column receiving wire is touched;
when the first absolute difference between the k^{th} differentially amplified signal and the reference value is greater than the first threshold, and the first absolute differences between the 1^{st} to the (k−1)^{th} differentially amplified signals and the reference value are all less than the first threshold, determining that the 1^{st} to the k^{th} column receiving wires are touched, wherein 1<k<i and k is a natural number;
when the first absolute differences between the (k−1)^{th} and the k^{th} differentially amplified signals and the reference value are greater than the first threshold, and a polarity of a difference between the (k−1)^{th} differentially amplified signal and the reference value is opposite to a polarity of a difference between the k^{th} differentially amplified signal and the reference value, determining that the k^{th} column receiving wire is touched;
when the first absolute differences between the m^{th} and the k^{th} differentially amplified signals and the reference value are greater than the first threshold, a polarity of a difference between the m^{th} differentially amplified signal and the reference value is opposite to the polarity of the difference between the k^{th} differentially amplified signal and the reference value, and the first absolute differences between the (m+1)^{th} to the (k−1)^{th} differentially amplified signals and the reference value are all less than the first threshold, determining that the (m+1)^{th} to the k^{th} column receiving wires are touched, wherein k>m≥1; and
when the second absolute difference between the second single-ended amplified signal and the reference value is not less than the second threshold, the first absolute difference between the (i−1)^{th} differentially amplified signal and the reference value is greater than the first threshold, and the first absolute differences between the 1^{st} to the (i−2)^{th} differentially amplified signals and the reference value are all less than the first threshold, determining that the i^{th} column receiving wire is touched.

5. A touch screen assembly, comprising a touch screen and a touch detection circuit, wherein the touch screen comprises multiple touch sensors arranged in an array, multiple row driving wires and multiple column receiving wires, each of the row driving wires is connected with all touch sensors on the corresponding row, and each of the column receiving wires is connected with all touch sensors on the corresponding column; and the touch detection circuit comprises:
a drive circuit, configured to provide driving signals to the row driving wires;
multiple first differential amplifiers, configured to differentially amplify outputs of any two adjacent column receiving wires separately to obtain multiple differentially amplified signals;
a second differential amplifier, configured to amplify an output of any column receiving wire to obtain a single-ended amplified signal; and
a processing circuit, connected to the first differential amplifiers and the second differential amplifier and configured to: when first absolute differences between each of the differentially amplified signals and a reference value are all less than a first threshold and a second absolute difference between the single-ended amplified signal and the reference value is not less than a second threshold, determine that all column receiving wires corresponding to the same row driving wire are touched; and when the first absolute differences are all less than the first threshold and the second absolute difference is less than the second threshold, determine that all column receiving wires corresponding to the same row driving wire are not touched, where
the reference value refers to an average value of the multiple differentially amplified signals in a case that the touch screen is not touched.

6. The touch screen assembly according to claim 5, wherein the touch detection circuit comprises multiple first resistors and a second resistor, each of the first resistors is connected between an input end and an output end of the corresponding first differential amplifier, and the second resistor is connected between an input end and an output end of the second differential amplifier.

7. The touch screen assembly according to claim 5, wherein two input ends of each of the first differential amplifiers are connected to two adjacent column receiving wires, respectively.

8. The touch screen assembly according to claim 5, wherein the touch detection circuit comprises two second differential amplifiers, the two second differential amplifiers are respectively connected to outputs of the 1^{st} column receiving wire and the i^{th} column receiving wire, and i is the number of the column receiving wires.

9. The touch screen assembly according to claim 5, wherein the drive circuit comprises row drive circuits, and each of the row drive circuits is configured to provide the driving signal to each of the row driving wire, respectively.

10. The touch screen assembly according to claim 5, wherein the drive circuit comprises row drive circuits and a multiplexer, the multiplexer is connected to the row drive circuits and the multiple row driving wires, and the row drive circuits are configured to simultaneously provide the driving signals to the row driving wires in different rows through the multiplexer.

11. The touch screen assembly according to claim 5, wherein the processing circuit comprises:
a low-pass filter, configured to remove noise of output signals of the multiple first differential amplifiers to obtain multiple first denoised signals, and remove noise of an output signal of the second differential amplifier to obtain a second denoised signal;
an integrator, configured to integrate the multiple first denoised signals and the second denoised signal to obtain multiple first integrated signals and a second integrated signal;
a sampler/converter, configured to perform sampling and analog-digital conversion on the multiple first integrated signals and the second integrated signal to obtain multiple first digital signals and a second digital signal, wherein the first digital signals serve as the differentially amplified signals and the second digital signal serves as the single-ended amplified signal; and
a processor, configured to process the first digital signals and the second digital signal to obtain relationships between the first absolute differences and the first threshold and a relationship between the second absolute difference and the second threshold.

12. The touch screen assembly according to claim 5, wherein there are i column receiving wires, the single-ended amplified signal comprises a first single-ended amplified signal obtained by amplifying an output of the 1^{st} column receiving wire and a second single-ended amplified signal obtained by amplifying an output of the i^{th} column receiving wire, i>2 and i is a natural number, and the multiple differentially amplified signals comprise i−1 differentially amplified signals; and the touch detection circuit is configured to:
when the second absolute difference between the first single-ended amplified signal and the reference value is not less than the second threshold, the first absolute difference between the 1^{st} differentially amplified signal and the reference value is greater than the first threshold, and the first absolute differences between the 2^{nd} to the (i−1)^{th} differentially amplified signals and the reference value are all less than the first threshold, determine that the first column receiving wire is touched;
when the first absolute difference between the k^{th} differentially amplified signal and the reference value is greater than the first threshold, and the first absolute differences between the 1^{st} to the (k−1)^{th} differentially amplified signals and the reference value are all less than the first threshold, determine that the 1^{st} to the k^{th} column receiving wires are touched, wherein 1<k<i and k is a natural number;
when the first absolute differences between the (k−1)^{th} and the k^{th} differentially amplified signals and the reference value are greater than the first threshold, and a polarity of a difference between the (k−1)^{th} differentially amplified signal and the reference value is opposite to a polarity of a difference between the k^{th} differentially amplified signal and the reference value, determine that the k^{th} column receiving wire is touched;
when the first absolute differences between the m^{th} and the k^{th} differentially amplified signals and the reference value are greater than the first threshold, a polarity of a difference between the m^{th} differentially amplified signal and the reference value is opposite to the polarity of the difference between the k^{th} differentially amplified signal and the reference value, and the first absolute differences between the (m+1)^{th} to the (k−1)^{th} differentially amplified signals and the reference value are all less than the first threshold, determine that the (m+1)^{th} to the k^{th} column receiving wires are touched, wherein k>m≥1; and
when the second absolute difference between the second single-ended amplified signal and the reference value is not less than the second threshold, the first absolute difference between the (i−1)^{th} differentially amplified signal and the reference value is greater than the first threshold, and the first absolute differences between the 1^{st} to the (i−2)^{th} differentially amplified signals and the reference value are all less than the first threshold, determine that the i^{th} column receiving wire is touched.

13. A display panel assembly, comprising a display panel and a touch screen assembly disposed on the display panel, the touch screen assembly comprises a touch screen and a touch detection circuit, wherein the touch screen comprises multiple touch sensors arranged in an array, multiple row driving wires and multiple column receiving wires, each of the row driving wires is connected with all touch sensors on the corresponding row, and each of the column receiving wires is connected with all touch sensors on the corresponding column; and the touch detection circuit comprises:
a drive circuit, configured to provide driving signals to the row driving wires;
multiple first differential amplifiers, configured to differentially amplify outputs of any two adjacent column receiving wires separately to obtain multiple differentially amplified signals;
a second differential amplifier, configured to amplify an output of any one of the column receiving wires at both ends to obtain a single-ended amplified signal; and
a processing circuit, connected to the first differential amplifiers and the second differential amplifier and configured to: when first absolute differences between each of the differentially amplified signals and a reference value are all less than a first threshold and a second absolute difference between the single-ended amplified signal and the reference value is not less than a second threshold, determine that all column receiving wires corresponding to the same row driving wire are touched; and when the first absolute differences are all less than the first threshold and the second absolute difference is less than the second threshold, determine that all column receiving wires corresponding to the same row driving wire are not touched, where
the reference value refers to an average value of the multiple differentially amplified signals in a case that the touch screen is not touched.
